(19) United States
(12) Patent Application Publication
(10) Pub. No.: US 2007/0224335 A1
(43) Pub. Date: Sep. 27, 2007

(54) Stable soy protein beverage composition

(76) Inventors: Shaowen Wu, St. Louis, MO (US); Traci Hamersen, St. Louis, MO (US); Thomas L. Krinski, Granite City, IL (US)

Correspondence Address: SOLAE, LLC, P. O. BOX 88940, ST. LOUIS, MO, 63188, US

(21) Appl. No.: 11/386,482

(22) Filed: Mar. 22, 2006

(51) Int. Cl. A23L 1/20

(52) U.S. Cl. 426/634; 426/656

(57) ABSTRACT

In a first embodiment, the invention is directed to a neutral beverage of an alkaline earth metal fortified soy protein composition dispersed in an aqueous medium, comprising; an aqueous slurry of a soy protein material and a hydrated gel of an alkaline earth metal phosphate salt, wherein the soy protein material has a beta-conglycinin content of from about 40% to about 85% and a glycinin content of from about 5% to about 40%, and wherein the alkaline earth metal content of the alkaline earth metal fortified soy protein composition is from about 1.5% to about 12% by weight, on a dry basis and wherein the alkaline earth metal fortified soy protein composition forms a stable suspension in the aqueous medium.

In a second embodiment, a soy milk beverage is prepared. The soy milk beverage is prepared by combining soybeans having a beta-conglycinin content of from about 40% to about 85% and a glycinin content of from about 5% to about 40%, with water, grinding the soybeans while in the water and separating the liquid as a soy milk.

### FIELD OF THE INVENTION

This invention relates to a soy protein based beverage composition that is smooth, tasteful, palatable and has good storage stability in either an acidic environment or a neutral environment. Stability is enhanced by the addition of stabilizers such as starch, pectin and hydrocolloids. The soy protein is fortified with a calcium or magnesium salt. The soy protein employed has a low phytic acid content of inositol-6-phosphate, inositol-5-phosphate, inositol-4-phosphate and inositol-3-phosphate. Further, the soy protein has a beta-conglycinin content of from about 40% to about 85% and a glycinin content of from about 5% to about 40%.

### BACKGROUND OF THE INVENTION

Protein isolates that are derived from vegetable protein sources, such as soybeans have contributed substantially to the economic importance of these materials as a crop. Soy protein isolates in particular have proven to be a useful nutritional supplement in a variety of foods and beverages. A protein isolate can be generally characterized as a product resulting from the extraction, subsequent concentration, and purification of proteinaceous material from a proteinaceous source such as a vegetable protein material. Typically, the protein isolate on a moisture free basis will have a protein content which will range between about 90% and 98% by weight.

The usefulness of soy protein isolates in the formation of foodstuffs such as beverages has for the most part been accomplished by the production of modified or enzymatically hydrolyzed isolates or the addition of materials such as surfactants to promote the dispersibility or suspendibility of the isolate in the particular type of aqueous medium that is used in preparation of the beverage.

An example of this type of protein product is described in U.S. Pat. No. 4,378,378 in which a simulated milk product of improved suspension characteristics is produced wherein a slurry of a vegetable protein material and dairy whey is formed, followed by the reaction of the slurry with a proteolytic enzyme. While protein isolates are generally dispersible in aqueous mediums, nevertheless it has been more difficult to employ these isolates in conjunction with certain vitamins and minerals that may be required, if a nutritionally complete beverage or drink, such as an infant formula is produced. For example, fortification of a liquid product with calcium represents a particular problem, since most forms of calcium that are employed for calcium supplementation in nutritional beverages are relatively insoluble in aqueous mediums. These materials readily precipitate or settle from aqueous suspension, thereby providing the user with a drink that must be shaken relatively often to ensure adequate consumption of the minerals in the diet.

Dispersibility of a mineral enriched protein composition has been described in U.S. Pat. No. 4,214,996, in which the mineral is chelated with an organic acid and a sugar for purposes of improving the dispersibility of the minerals in an aqueous medium such as a beverage. It is indicated that the product can be dried and reconstituted with good results.

An alternative approach to the dispersibility of specific mineral fortifying substances, such as calcium phosphate, is set forth in U.S. Pat. No. 2,605,229. This describes the production of a calcium phosphate gel which will remain dispersed in water when mixed therewith to yield a milky suspension simulating the dispersion of calcium phosphate in milk.

### SUMMARY OF THE INVENTION

In a first embodiment, the invention is directed to a neutral beverage of an alkaline earth metal fortified soy protein composition dispersed in an aqueous medium, comprising; an aqueous slurry of a soy protein material and a hydrated gel of an alkaline earth metal phosphate salt, wherein the soy protein material has a beta-conglycinin content of from about 40% to about 85% and a glycinin content of from about 5% to about 40%, and wherein the alkaline earth metal content of the alkaline earth metal fortified soy protein composition is from about 1.5-12% by weight, on a dry basis and wherein the alkaline earth metal fortified soy protein composition forms a stable suspension in the aqueous medium.

In a second embodiment, the invention is directed to a soy protein composition dispersed in an aqueous medium, comprising; an aqueous slurry of a soy protein material, wherein the soy protein material has a beta-conglycinin content of from about 40% to about 85% and a glycinin content of from about 5% to about 40%, and wherein the soy protein composition forms a stable suspension in the aqueous medium.

### DETAILED DESCRIPTION OF THE INVENTION

To provide an understanding of several of the terms used in the specification and claims, the following definitions are provided.

High beta-conglycinin soybeans: As used herein, high beta-conglycinin soybeans refers to soybean seeds having greater than about 40% of the protein as beta-conglycinin.

Soy protein isolate (SPI): As used herein, soy protein isolate is a spray-dried powder made from soybeans containing not less than 90% protein (N times 6.25) on a moisture-free basis.

High beta conglycinin soybeans seeds are processed into high beta conglycinin soy protein extracts as described below.

### The Soy Protein Material

Soybean proteins are composed of four globulin fractions: 2S having a molecular weight from about 8,000 to about 21,500; 7S (beta-conglycinin) having a molecular weight from about 150,000 to about 200,000; 11S (glycinin) having a molecular weight of about 350,000 and 15S having a molecular weight of about 600,000. In the present invention, the starting material soybean is a genetically modified organism available from DuPont, Wilmington, Del., identified as Version 1, IA Bean No. 408, having a 7S content of 65.5 and an 11S content of 9.7.

The soy protein material utilized within the present invention for both embodiments has a beta conglycinin content of from about 40% to about 85% of the total weight of the soy protein and a glycinin content of from about 5% to about 40% of the total weight of the soy protein. The use of high beta conglycinin soybeans which contain more than about 40% beta conglycinin, enable the preparation of a soy protein material having a beta conglycinin content of from about 40% to about 85% without the inefficiencies of removing glycinins during processing. The high beta conglycinin soy protein material of the present invention contains from about 40% to about 85% beta conglycinin, compared to 26-29% in commercial soy protein isolates. Typically soy protein isolates, a typical starting material for beverages, contain about 40-45% glycinin. The high beta conglycinin soy protein material of the present invention contains less than about 40% glycinin.

### The First Embodiment

In the first embodiment, a ready to drink neutral (RTD-N) beverage is prepared. Typically RTD-N beverages are mineral enriched or fortified. Mineral fortification takes place by the addition of a hydrated gel of a mineral fortifying material to a hydrated high beta conglycinin soy protein isolate slurry.

High beta conglycinin soy protein isolate, as the term is used herein, refers to a soy protein material containing about 90% or greater protein content, and preferably about 95% or greater soy protein content, wherein the beta conglycinin fraction is from about 40% to about 85%, preferably from about 45% to about 70% and a glycinin content of from about 5% to about 40%, preferably from about 15% to about 35% of the total soy protein. The high beta conglycinin soy protein isolate is typically produced from a starting material, such as defatted high beta conglycinin soybean material, in which the oil is extracted to leave soybean meal or flakes. More specifically, the high beta conglycinin soybeans may be initially crushed or ground and then passed through a conventional oil expeller. It is preferable, however, to remove the oil contained in the soybeans by solvent extraction with aliphatic hydrocarbons, such as hexane or azeotropes thereof, and these represent conventional techniques employed for the removal of oil. The defatted, high beta conglycinin soy protein flakes are then placed in an aqueous bath to provide a mixture having a pH of at least about 6.5 and preferably between about 7.0 and 10 in order to extract the protein. Typically, if it is desired to elevate the pH above 6.7 various alkaline reagents such as sodium hydroxide, potassium hydroxide and calcium hydroxide or other commonly accepted food grade alkaline reagents may be employed to elevate the pH. A pH of above about 7 is generally preferred, since an alkaline extraction facilitates solubilization of the protein. Typically, the pH of the aqueous extract of the high beta conglycinin soy protein, will be at least about 6.5 and preferably about 7.0 to 10. The ratio by weight of the aqueous extractant to the soy protein material is usually between about 20 to 1 and preferably a ratio of about 10 to 1. In an alternative embodiment, the soy protein is extracted from the milled, defatted flakes with water, that is, without a pH adjustment.

It is also desirable in obtaining the high beta conglycinin soy protein isolate used in the present invention, that an elevated temperature be employed during the aqueous extraction step, either with or without a pH adjustment, to facilitate solubilization of the soy protein, although ambient temperatures are equally satisfactory if desired. The extraction temperatures which may be employed, can range from ambient up to about 120° F. with a preferred temperature of 90° F. The period of extraction is further non-limiting and a period of time between about 5 to 120 minutes may be conveniently employed with a preferred time of about 30 minutes. Following extraction of the vegetable protein material, the aqueous extract of protein can be stored in a holding tank or suitable container while a second extraction is performed on the insoluble solids from the first aqueous extraction step. This improves the efficiency and yield of the extraction process by exhaustively extracting the protein from the residual solids from the first step.

The combined, aqueous protein extracts from both extraction steps, without the pH adjustment or having a pH of at least 6.5, or preferably about 7.0 to 10, are then precipitated by adjustment of the pH of the soy extracts to, at or near the isoelectric point of the high beta conglycinin soy protein to form an insoluble curd precipitate. The pH is typically between about 4.0 and 5.0. The precipitation step may be conveniently carried out by the addition of a common food grade acidic reagent such as acetic acid, sulfuric acid, phosphoric acid, hydrochloric acid or with any other suitable acidic reagent. The high beta conglycinin soy protein precipitates from the acidified extract, and is then separated from the extract. The separated high beta conglycinin soy protein isolate may be washed with water to remove residual soluble carbohydrates and ash from the protein material. The separated protein is then dried using conventional drying means to form a high beta conglycinin soy protein isolate.

The soy protein curd is then formed into an aqueous slurry for purposes of mineral fortification as described below. Although the protein isolate can be obtained directly from the isolation procedure as described above, in which the precipitated protein is still in the form of an aqueous suspension, it is equally possible insofar as the present invention to employ as a starting material a dried protein isolate which is dispersed into an aqueous medium to form an aqueous suspension.

An essential aspect of this embodiment, however, is the particular means for mineral fortification of the protein material. It has been found, for example, that if mineral fortification of the protein material takes place by the addition of a hydrated gel of the mineral fortifying material as compared to the addition of a dried, mineral supplement, a product of improved suspension characteristics is achieved. The improved suspension characteristics are also retained after drying of the fortified protein composition.

The hydrated gel is an alkaline earth metal salt. Typical alkaline earth materials used for mineral fortification and which are considered to be essential for nutritional purposes include calcium and magnesium. Calcium has proven to be a particular problem insofar as fortification of protein supplements for liquid foodstuffs, since it is used at a higher fortification level than other minerals, in an aqueous medium such as an infant formula or nutritional beverage. For the most part, this has been accomplished in the prior art by the dispersal of a dried calcium phosphate salt in the dried protein supplement, which upon dispersion in an aqueous medium, still often results in settling of the mineral components during storage of the liquid foodstuff.

While the first embodiment is particularly directed toward the production of calcium fortified, high beta-conglycinin soy protein compositions of improved suspension characteristics, it is equally adaptable to other bivalent salts such as the alkaline earth metals salts normally used for mineral fortification of foodstuffs such as magnesium. The exact means of forming the hydrated gel of the various alkaline earth metal salts is not critical to the practice of the present invention and these gels can be prepared by a variety of chemical reactions. Specifically insofar as calcium, a reaction between calcium chloride and trisodium phosphate can be used to form a hydrated gel of tricalcium phosphate according to the following reaction.

3CaCl₂+2Na₃PO₄→Ca₃(PO₄)₂+6NaCl

Alternatively, a reaction between calcium hydroxide and phosphoric acid can be used with an equal degree of success to form a hydrated gel of tricalcium phosphate according to the following reaction.

3Ca(OH)₂+2H₃PO₄→Ca₃(PO₄)₂+6H₂O

The above reactions represent typical reactions for the production of a hydrated gel of an alkaline earth metal such as calcium that has been specifically found to improve the suspension characteristics of a vegetable protein material of which it is fortified.

Insofar as the production of a hydrated gel of a calcium salt, it is preferable to employ the reaction set forth above in which calcium hydroxide is reacted with phosphoric acid, because no salt is produced by this reaction. Typically, a dilute solution of calcium hydroxide is employed for a reaction with the phosphoric acid and although the exact concentration of calcium is not limiting it is preferable that the calcium level in the solution be about 0.1 to 3.0% by weight, preferably about 1.0% by weight. To this solution, is added in drop-wise fashion, concentrated phosphoric acid (85% by weight) at a uniform and slow enough rate so that the pH of the reaction mixture is maintained above about 7. It is desirable to maintain the pH of the reaction medium to above about 7 and preferably from about 9.5 to 11.5 for purposes of producing the tricalcium phosphate which is the preferred material for purposes of calcium fortification of the protein composition. If the pH of the reaction mixture is allowed to fall below about 7 then, primarily the mono and dibasic forms of calcium phosphate are formed and while these may be used with equal success in the fortification of protein materials, and are intended to be covered by the present invention, it is preferred that the tricalcium phosphate be used since, this material is the most stable form of calcium phosphate, for purposes of calcium fortification.

The reaction is allowed to proceed and a translucent hydrated gel of tricalcium phosphate begins to form. The hydrated gel, upon centrifugation provides a gel having a solids content of less than about 10% by weight preferably about 7 to 10 percent by weight. It is this hydrated translucent, gel of tricalcium phosphate which has been found to provide a soy protein composition of improved suspension characteristics when it is used to provide mineral fortification of the soy protein composition. It is important that the hydrated gel not be dried prior to addition to the high beta conglycinin soy protein slurry, since this has been found not to result in a mineral fortified soy protein composition which has the desired suspension characteristics.

The hydrated, mineral gel is then added to the high beta conglycinin soy protein isolate slurry in an amount effective to provide a mineral fortified protein composition, with the exact amount to be added, to be dependent upon the degree of fortification desired, typically from about 1.5% to about 12% alkaline earth metal, on a dry basis. For example in the case of adults, a level of about 1.5% calcium based upon the protein solids in the mineral fortified protein composition is sufficient to meet the daily requirement, whereas, in the case of infants or in the event one wants to simulate milk by providing a comparable calcium level, the level is usually about 2.7%-3.5% or higher. Therefore the exact amount of gel added, is entirely dependent upon the degree of fortification desired, and the specific amount added is not intended to limit the present invention.

While it is preferable to employ a heating step as set forth below, a heating step is not essential to this embodiment and can be deleted if desired. It is not critical, whether or not the heating step be employed before or after addition of the hydrated gel to the high beta conglycinin soy protein isolate slurry. The high beta conglycinin soy protein isolate slurry, containing the hydrated gel added for purposes of fortifying the high beta conglycinin soy protein isolate, is then heated at a temperature of about 220° F. to 400° F., and preferably at a temperature of 260° F. to 310° F. for a few seconds up to several minutes, and preferably about 7 to 100 seconds. Preferably, heating is carried out in a jet cooker or similar apparatus, in which jets of steam intersect segments of the slurry in such a manner, that the mineral fortified protein composition slurry is dynamically heated under conditions of both elevated temperature and pressure. Following heating of the mineral fortified protein composition slurry under the dynamic conditions of elevated temperature and pressure, the slurry with the protein and minerals is typically ejected into a container of lower pressure which causes volatilization of a portion of the water, contained in the slurry with resultant cooling of the slurry to a temperature of about 150° F. or less.

The cooled mineral fortified protein composition slurry can then be dewatered by any type of drying procedure, but it is preferred to spray-dry the mineral fortified protein composition slurry to provide the most uniform mixture of the mineral fortifying salt and the protein and provide a product which has excellent dispersibility characteristics in aqueous mediums. The dried product has excellent suspension characteristics in a liquid foodstuff, and overcomes the separation problems normally associated with using mineral fortified protein compositions in liquid foodstuffs, such as nutritional beverages.

A hydrated gel gel of an alkaline earth metal salt is prepared for purposes of providing a means for mineral enrichment of the protein material, wherein a mineral fortified protein composition is formed that has improved suspension characteristics when used in the production of a liquid foodstuff such as a nutritional beverage. Typical alkaline earth materials used for mineral fortification and which are considered to be essential for nutritional purposes include calcium and magnesium. Calcium has proven to be a particular problem insofar as fortification of protein supplements for liquid foodstuffs, since it is used at a higher fortification level than other minerals, in an aqueous medium such as an infant formula or nutritional beverage. For the most part, this has been accomplished in the prior art by the dispersal of a dried calcium phosphate salt in the dried protein supplement, which upon dispersion in an aqueous medium, still often results in settling of the mineral components during storage of the liquid foodstuff.

While the present invention is particularly directed toward the production of calcium fortified, protein compositions of improved suspension characteristics, it is equally adaptable to other bivalent salts such as the alkaline earth metals salts normally used for mineral fortification of foodstuffs such as magnesium. The exact means of forming the hydrated gel of the magnesium or calcium alkaline earth metal salts is critical to the practice of the present invention. The hydrated gel is formed by reacting phosphoric acid with either magnesium hydroxide or calcium hydroxide in the presence of, or followed by either ultrasonication or homogenization.

An aqueous slurry of calcium hydroxide or magnesium hydroxide is prepared by adding calcium hydroxide or magnesium hydroxide, respectively to water. Alternatively, the alkaline earth metal hydroxide can be prepared in situ by reacting calcium oxide or magnesium oxide with water. The alkaline earth metal hydroxides have limited solubility in water. However, it is not necessary for the alkaline earth metal hydroxides to be in solution in order to react with the phosphoric acid to form a hydrated gel. An aqueous slurry of alkaline earth metal hydroxide will suffice. The alkaline earth metal hydroxide slurry, either prepared from an alkaline earth metal hydroxide or prepared in situ, contains from 2 up to 10%, preferably up to 8% and most preferably up to 7% by weight alkaline earth metal hydroxide.

A stoichiometric amount of phosphoric acid at from 10 to 85% is quickly added to the alkaline earth metal hydroxide slurry at from 30 seconds to 5 minutes, depending upon the batch size, while employing, or followed by ultrasonication or homogenization. There is no need to keep the pH of the reaction on the basic side. The ultrasonication and homogenization serve to reduce the particle size of the alkaline earth metal hydroxide and provide mechanical energy such that all the alkaline earth metal hydroxide reacts with the phosphoric acid. The ultrasonication and homogenization also serve to reduce the particle size of the hydrated gel of the formed alkaline earth metal phosphate salt.

The reaction of phosphoric acid with the alkaline earth metal hydroxide produces an alkaline earth metal phosphate salt, especially a tri-alkaline earth metal phosphate salt and preferred is tricalcium phosphate.

The homogenization can be carried out using a conventional homogenizer. Preferably the homogenization is effected using an APV Gaulin homogenizer at from 500-2000 pounds per square inch. Ultrasonication can be carried out using a Model A, ultrasonic mixing device sold under the trade name Sonolator by the Sonics Corporation. For ultrasonication, the pressure is from 1000-1500 pounds per square inch. The hydrated gel, especially as tricalcium phosphate is insoluble in an aqueous medium. The amount of the hydrated gel present as solids after the reaction of the alkaline earth metal hydroxide and phosphoric acid is generally from about 3.0% up to about 14.0%, preferably up to about 11% and most preferably up to about 10% by weight.

Mineral enrichment or fortification of the soy protein material with the hydrated gel is accomplished by adding the hydrated gel to the soy protein material. The ratio of hydrated gel to soy protein material is dependent upon the alkaline earth metal content desired, on a dry basis.

The following examples represent a specific but non-limiting first embodiment of the present invention.

### EXAMPLE 1

A soy protein isolate is prepared in which 150 pounds per hour of defatted soybean flakes are fed to an extraction tank to which is added 1500 pounds per hour of water which is heated to 90° F. Sufficient calcium hydroxide is added to adjust the pH of the mixture to 9.7. The soy flakes are extracted for a period of 30 minutes after which the aqueous solution is separated from the extracted flakes by centrifugation. The first aqueous extract is held while the extracted flake residue is redispersed in 900 pounds per hour of water at a temperature of 90° F. The pH of the mixture at this point is 9.0.

A second aqueous extract from the flakes is obtained by centrifugation and combined with the first aqueous extract. To the combined extracts, 37% hydrochloric acid is added to adjust the pH to 4.5 and precipitate the protein. The precipitated protein is then centrifuged to remove excess liquid to a solids level of 24-28% by weight. The precipitated protein is then diluted with water to form a slurry having a solids level of 7.5% by weight. The pH of the slurry is adjusted to 6.6 by the addition of sodium hydroxide.

A mixture of 2.3% calcium hydroxide and water is prepared by adding 230 grams calcium hydroxide to 9536 grams water, with stirring. The calcium hydroxide is permitted to disperse in the water for 1 hour. An amount of 85% phosphoric acid (238 grams) is added over a 30 minute period. At the end of the acid addition, the contents are permitted to stir for an additional 30 minutes. The slurry is transferred to a Gaulin homogenizer (model 15MR) and homogenized at 1500 pounds per square inch. The resulting hydrated gel of tricalcium phosphate has a solids content of 3.21%.

The hydrated gel is added in an amount sufficient to provide a calcium level of 2.6% by weight of the protein solids on a dry basis and the fortified slurry was allowed to equilibrate for 1 hour. The calcium fortified slurry is then passed through a jet cooker at a pressure of 85 pounds per square inch. The steam heats the slurry in the jet cooker to a temperature of 310° F. After 8-10 seconds, progressive portions of the heated slurry are discharged into a receiver at below atmospheric pressure. The mineral fortified slurry is then spray dried to a moisture level of less than 5% by weight.

The following examples are directed to the preparation of hydrated gels of trialkaline earth metal phosphate salts from the reaction of calcium hydroxide and phosphoric acid.

### EXAMPLE 2

The procedure of the hydrated gel of Example 1 is repeated except that 4% (400 grams) calcium hydroxide is added to 9186 grams water and reacted with 414 grams of 85% phosphoric acid. After homogenization, the hydrated gel of tricalcium phosphate has a solids content of 5.58%.

### EXAMPLE 3

The procedure of the hydrated gel of Example 1 is repeated except that 5% (500 grams) calcium hydroxide is added to 8982 grams water and reacted with 518 grams of 85% phosphoric acid. After homogenization, the hydrated gel of tricalcium phosphate has a solids content of 6.64%.

### EXAMPLE 4

The procedure of the hydrated gel of Example 1 is repeated except that the slurry of calcium hydroxide and phosphoric acid is subjected to sonication instead of homogenization. The hydrated gel of tricalcium phosphate has a solids content of 3.21%.

The hydrated, mineral gels from any of Examples 2-4 is then added to the protein slurry in an amount effective to provide a mineral fortified protein composition, with the exact amount to be added, to be dependent upon the degree of fortification desired. For example in the case of adults, a level of about 1.5% calcium based upon the protein solids in the mineral fortified protein composition is sufficient to meet the daily requirement, whereas, in the case of infants or in the event one wants to simulate milk by providing a comparable calcium level, the level is usually about 2.7%-3.5% or higher. Therefore the exact amount of gel added, is entirely dependent upon the degree of fortification desired, and the specific amount added is not intended to limit the present invention.

Preferably the high beta conglycinin soy protein material used in the present invention, is modified to enhance the characteristics of the soy protein material. The modifications are modifications which are known in the art to improve the utility or characteristics of a soy protein material and include, but are not limited to, denaturation and hydrolysis of the protein material.

The high beta conglycinin soy protein material may be denatured and hydrolyzed to lower the viscosity. Chemical denaturation and hydrolysis of protein materials is well known in the art and typically consists of treating a protein material with one or more alkaline reagents in an aqueous solution under controlled conditions of pH and temperature for a period of time sufficient to denature and hydrolyze the protein material to a desired extent. Typical conditions utilized for chemical denaturing and hydrolyzing the high beta conglycinin soy protein material are: a pH of up to about 10, preferably up to about 9.7; a temperature of about 50° C. to about 80° C. and a time period of about 15 minutes to about 3 hours, where the denaturation and hydrolysis of the protein material occurs more rapidly at higher pH and temperature conditions.

Hydrolysis of the high beta conglycinin soy protein material may also be effected by treating the soy protein material with an enzyme capable of hydrolyzing the protein. Many enzymes are known in the art which hydrolyze protein materials, including, but not limited to, fungal proteases, plant proteases, peptases, and chymotrypsin. Enzyme hydrolysis is effected by adding a sufficient amount of enzyme to an aqueous dispersion of protein material, typically from about 0.1% to about 10% enzyme by weight of the protein material, and treating the enzyme and protein dispersion at a temperature, typically from about 5° C. to about 75° C., and a pH, typically from about 3 to about 9, at which the enzyme is active for a period of time sufficient to hydrolyze the soy protein material. After sufficient hydrolysis has occurred the enzyme is deactivated by heating, and the soy protein material is precipitated from the solution by adjusting the pH of the solution to about the isoelectric point of the protein material.

A particularly preferred modified soy protein material is a soy protein isolate that has been enzymatically hydrolyzed and deamidated under conditions that expose the core of the proteins to enzymatic action as described in European Patent No. 0 480 104 B1, which is incorporated herein by reference. Briefly, the modified protein isolate material disclosed in European Patent No. 0 480 104 B1 is formed by: 1) forming an aqueous slurry of a soy protein isolate; 2) adjusting the pH of the slurry to a pH of from 9.0 to 11.0; 3) adding between 0.01 and 5% of a proteolytic enzyme to the slurry (by weight of the dry protein in the slurry); 4) treating the alkaline slurry at a temperature of 10° C. to 75° C. for a time period effective to produce a modified protein material having a molecular weight distribution (Mn) between 800 and 4000 and a deamidation level of between 5% to 48% (typically between 10 minutes to 4 hours); and deactivating the proteolytic enzyme by heating the slurry above 75° C. The modified protein material disclosed in European Patent No. 0 480 104 B1 is commercially available from Protein Technologies International, Inc of St. Louis, Mo.

It is also preferred to reduce the phytic acid content of the high beta conglycinin soy protein material. Phytic acid or phytate is the hexa-phosphorus ester of inositol (1, 2, 3, 4, 5, 6-cyclohexanehexolphosphoric acid), found in many seeds and cereals. It acts as the primary storage form of both phosphorus and inositol and accounts for as much as 50% of the total phosphorus content. Phytic acid in plants appears in the form of calcium, magnesium and potassium salts, which in general are called phytin. A large part of the phosphorus content of seeds is stored in these compounds. For example, about 70% of the total phosphorus in soybeans is accounted for by phytin. When the terms phytate or phytic acid are used herein, it is intended to include salts of phytic acid and molecular complexes of phytic acid with other soybean constituents.

All legumes contain phytic acid. However, soybeans have higher levels of phytic acid than any other legume. Phytic acid tends to form complexes with proteins and multivalent metal cations. Phytic acid complexes decrease the nutritional quality of soy protein. Phytic acid, because it interacts with multivalent metal cations, interferes with the assimilation by animals and humans of various metals such as calcium, iron and zinc. This may lead to deficiency disorders, especially for vegetarians, elderly people and infants.

Phytic acid also inhibits various enzymes in the gastrointestinal tract, including pepsin and trypsin and decreases the digestibility of soy protein. In addition, the phosphate present in phytic acid is not available to humans. Moreover, the presence of a relatively large amount of such unavailable phosphorus in infant food many lead to inadequate bone mineralization.

In typical commercial soy protein isolation processes, defatted soy flakes or soy flour are slurried with water and a base and extracted at pH values between 8.0 and 10.0 to solubilize proteins. The slurry is centrifuged to separate the insoluble part from the solution. The major fraction is recovered from the solution by precipitating at a pH near the isoelectric point of the protein (4.5), separating it by centrifugation, washing the precipitate with water redispersing it at pH 7 and spray-drying it to a powder. In such processes, phytic acid will follow the protein and tends to concentrate in the resulting soy protein product. The phytic acid content of commercial soy protein isolates is about 1.2-3%, whereas soybeans contain 1-2% phytic acid.

For beverage compositions, it is important that the soy protein material have a reduced level of phytic acid. To remove the phytic acid, it is necessary to employ a phytate-degrading enzyme. The phytate-degrading enzyme reacts with phytic acid to generate inositol and orthophosphate as well as several forms of inositolphosphates as intermediate products. The phytate-degrading enzyme includes at least one of phytase and acid phosphatase. Particularly preferred enzymes are sold under the trademark Finase® S by Alko Ltd., Helsinki, Finland; Amano 3000 from Amano Pharmaceutical Co., LTD, Nagoya, Japan and Natuphos® Phytase from BASF Corp., Wyandotte, Mich.

Phytase and acid phosphatases are produced by various microorganisms such as Aspergillus spp., Rhizopus spp., and yeasts (Appl. Microbiol. 16:1348-1357 (1968; Enzyme Microb. Technol. 5:377-382 (1983)), and phytase is also produced by various plant seeds, for example wheat, during germination. According to methods known in the art, enzyme preparations can be obtained from the above mentioned organisms. Caransa et al, Netherlands Pat. Appl. 87.02735, found that at the same enzyme dosage phytase from Aspergillus spp. degraded phytic acid in corn more efficiently than phytase from wheat.

Particularly preferred for the purposes of the present invention are the Finase enzymes, formerly termed Econase EP 43 Enzymes, manufactured by Alko Ltd., Rajamaki, Finland. These are described in U.S. application Ser. Number 242,243, filed Sep. 12, 1988.

Typically phytase degrading enzymes are added to the soy protein extract prior to acid precipitation to reduce the phytic acid. This may be carried forth before or after mineral fortification. The amount of phytate degrading enzyme required will depend upon the phytic acid content of the raw material and the reaction conditions. The right dosage can easily be estimated by a person skilled in the art. Generally the concentration of the phytate degrading enzyme is from about 500 to about 2200, preferably from about 600 to about 2100 and most preferably from about 720 to about 1400 units of phytase (phytase unit) per gram of soy protein, which is usually expressed as PU/g. One Phytase Unit (PU) is defined as the amount of enzyme which under standard conditions (i.e. at pH 5.5, 37° C., a substrate concentration of 5.0 mM sodium phytate, and a reaction time of 30 minutes) liberates 1 μmol of phosphate per minute.

### The Second Embodiment

In the second embodiment, a soy milk beverage is prepared. The soy milk beverage is prepared by combining soybeans having a beta-conglycinin content of from about 40% to about 85% and a glycinin content of from about 5% to about 40%, with water. In preparing soy milk, the high beta conglycinin soybeans are soaked in water and are ground by using, for example, a grinder, mixer, mass-colloider, etc. The grinding of the high beta conglycinin soybeans in water produces a go. The go is separated to give soy milk and okara. Okara is a by-product in the production of soy bean products such as soy milk and tofu. The go is then heated and separated into the water soluble fraction of soy milk and the water insoluble fraction of okara.

The go is heated at about 45 to 65° C. for about 10 seconds up to about 20 minutes. The heating temperature preferably ranges from about 50 up to about 65° C., still preferably from about 55 up to about 65° C. The heating time preferably ranges from about 20 seconds up to about 10 minutes, still preferably from about 3 up to about 7 minutes.

The go may be heated by any way without restriction. Namely, it may be fed into a pot or the like and then indirectly heated with an electric heater, etc. Alternatively, it may be directly heated by, for example, blowing live steam thereto. Either method makes it possible to obtain processed soybean protein foods with excellent qualities.

Next, the go thus heated is separated out into okara and soy milk. Although it is preferable to separate the go without cooling, it may be cooled prior to the separation. When heated, the go may be separated out immediately after attaining the desired temperature. Alternatively, it may be maintained at the desired temperature for a definite period of time and then separated out. The go may be separated out by a conventional method by using, for example, a centrifugal or hydraulic separation equipment.

In order to reduce the phytic acid content, a phytate-degrading enzyme is added to either the go before separation or to the soy milk after removal of the okara. The phytate degrading enzymes are as discussed above.

In the production process of the present invention, the method for concentration is not particularly restricted. For example, vacuum concentration may be effected with the use of an evaporator or a centrifugal separator. It is not preferable to carry out the concentration under atmospheric pressure, though possible, since it is feared that the soy milk is denatured by heating. When concentrated soy milk is reconstituted by dilution and changes in the properties before and after the concentration are examined, no change is caused by the concentration up to about 3.5-fold. It is, therefore, obvious that according to the production process of the present invention, the soy milk concentrated to a considerably high extent can sustain its properties.

By diluting with water, the concentrated soy milk produced can be reconstituted into one having the same extent of protein denaturation as that prior to the concentration. Thus it is usable in many ways similar to the common soy milk.

To obtain a powdery soy milk, the liquid soy milk is subjected to spray drying. It is preferable to regulate the inlet temperature and the outlet temperature respectively to from about 90 up to about 130° C. and from about 20 up to about 65° C. It is still preferable to regulate the inlet temperature and the outlet temperature respectively to from about 100 up to about 120° C. and from about 50 up to about 60° C. It is furthermore preferable to regulate the inlet temperature and the outlet temperature respectively to about 120° C. and about 60° C. The outlet temperature varies depending on the distance from the inlet to the outlet. When the inlet temperature has been determined, the relationship between the distance from the inlet to the outlet and the outlet temperature can be confirmed by a method well known by those skilled in the art. The spray drying is carried out in the conventional manner with the use of a spray dryer commonly employed by those skilled in the art.

The powdery soy milk obtained by spray drying has a high stability, light weight and small volume, compared with liquid soy milk. Therefore, powdery soy milk is highly suitable for storage. This powdery soy milk can be easily reconstituted into soy milk by dissolving in water. Thus, various foods can be produced by further processing this powdery soy milk. It is also possible to mix the powdery soy milk directly with other food components followed by processing, without reconstituting into liquid soy milk.

It has been found that when frozen, the soy milk or the concentrated soy milk can be stored for a long time in a stable state while inhibiting the denaturation of soybean protein. The present invention also provides frozen soy milk and processed soybean protein foods produced by using the frozen soy milk.

To produce the frozen soy milk of the present invention, freezing may be carried out by any method without restriction. For example, the soy milk may be slowly frozen in a refrigerator. Alternatively, it may be quickly frozen by blowing a gas, for example, carbon dioxide gas or nitrogen gas thereto. It has been confirmed that either method makes it possible to maintain the properties of the soy milk without any significant difference.

When stored, the frozen soy milk of the present invention is maintained at such a temperature as to keep the frozen state. The storage temperature is preferably about −15° C. or below, more preferably about −20° C. or below, still more preferably about −25° C. or below and still more preferably about −30° C. or below. It is the most common practice to store the frozen soy milk in a freezer, though the present invention is not restricted thereto. At a high storage temperature, there is a possibility that the protein is denatured and thus the utility value of the soy milk is deteriorated. By using such soy milk, less elastic and poor processed soybean protein foods such as tofu are produced. Accordingly, it is necessary that the frozen soy milk is employed before the denaturation of protein proceeds to an undesirable level. The relationship between the storage temperature and the shelf life can be optionally known by those skilled in the art.

To further illustrate the present invention in greater detail, and not by way of limitation, the following examples are given. The following examples are directed to the preparation of a soy milk from commodity soybeans (baseline) and from soybeans that have a beta-conglycinin content of from about 40% to about 85% and a glycinin content of from about 5% to about 40% (present invention).

### EXAMPLE 5

### Baseline

About 0.4 kg of dried commodity soybeans are soaked in 1.0 kg water at about 15° C. The soaked soybeans are then ground in a grinder while adding 1.12 kg of water thereto to form a go. About 2 kg of the go is fed into an enameled pot and heated to about 60° C. over 8 minutes while thoroughly stirring so as to prevent the go from burning. When the temperature reaches about 60° C., the go is immediately pressed with a simple press provided with a jack. The okara is separated out and 1.47 kg of soy milk is obtained.

### EXAMPLE 6

The procedure of Example 5 is repeated wherein the commodity soybeans are replaced with high beta conglycinin soybeans identified as Version 1, IA Bean No. 408 from DuPont having a 7S content of 65.5 and an 11S content of 9.7.

The comparative soy milk Example 5 is compared to the inventive soy milk Example 6 in a side-by-side serum test. The serum level is determined on samples that have been refrigerated at 4° C. The side-by-side comparison is made by filling 250 milliliter narrow mouth square bottles (Nalge Nunc International) with each soy milk. The percentage of serum of each sample is then measured to determine the effectiveness of stabilization in each soy milk. The serum is the clear layer of solution containing little or no suspended protein). The percentage of serum is determined by measuring the height of the serum layer in the sample and measuring the height of the entire sample, where Percent Serum=(Ht. Serum Layer)/(Ht. Total Sample)×100.

TABLE I

% Serum Data

| Days | Example 5 | Example 6 |
|---|---|---|
| 10 | 12% | — |
| 13 | 15 | — |
| 22 | 18 | 0.15 |
| 30 | 20.5 | 0.2 |
| 38 | 20 | 0.2 |
| 43 | 20.6 | 1.0 |
| 51 | 25.0 | 1.3 |
| 65 | 27.5 | 1.0 |

It is observed from the data of Table 1 that the % serum of the instant invention is much improved over the % serum of the Baseline.

While the invention has been explained in relation to its preferred embodiments, it is to be understood that various modifications thereof will become apparent to those skilled in the art upon reading the description. Therefore, it is to be understood that the invention disclosed herein is intended to cover such modifications as fall within the scope of the appended claims.

What is claimed is:

1. An alkaline earth metal fortified soy protein composition dispersed in an aqueous medium, comprising; an aqueous slurry of a soy protein material and a hydrated gel of an alkaline earth metal phosphate salt, wherein the soy protein material has a beta-conglycinin content of from about 40% to about 85% and a glycinin content of from about 5% to about 40%, and wherein the alkaline earth metal content of the alkaline earth metal fortified soy protein composition is from about 1.5% to about 12% by weight, on a dry basis and wherein the alkaline earth metal fortified soy protein composition forms a stable suspension in the aqueous medium.

2. The composition of claim 1 wherein the alkaline earth metal of the alkaline earth metal salt is a magnesium or calcium.

3. The composition of claim 1 wherein the alkaline earth metal salt is tricalcium phosphate.

4. The composition of claim 1 wherein the hydrated gel is formed by reaction between an alkaline earth metal hydroxide and a mineral acid at a pH above about 7.

5. The composition of claim 1 wherein the soy protein material is hydrolyzed with a protease enzyme at from about 0.1% to about 10% enzyme by weight of the protein material.

6. The composition of claim 1 wherein the soy protein material is treated with a phytate degrading enzyme.

7. The composition of claim 6 wherein the phytate degrading enzyme includes at least one of phytase and acid phosphatase.

8. A soy beverage composition prepared by a process of combining soybeans and water, wherein the soybeans have a beta-conglycinin content of from about 40% to about 85% and a glycinin content of from about 5% to about 40%.

9. The beverage of claim 8 wherein the soybeans are ground while in the water to produce a go.

10. The beverage of claim 9 wherein the go is heated at from about 45° C. up to about 65° C. for about 10 seconds up to about 20 minutes.

11. The beverage of claim 10 wherein the heated go is separated into okara and soy milk.

12. The beverage of claim 10 wherein the soy milk is spray dried.

13. The beverage of claim 10 wherein the soy milk is treated with a phytate-degrading enzyme.

14. The beverage of claim 13 wherein the phytate degrading enzyme includes at least one of phytase and acid phosphatase.
